(19) United States
(12) Patent Application Publication
(10) Pub. No.: US 2019/0102843 A1
(43) Pub. Date: Apr. 4, 2019

(54) Financial Analysis Apparatus, Financial Analysis Method And Storage Medium

(71) Applicant: Ernst & Young Shinnihon LLC, Tokyo (JP)

(72) Inventors: Naoto Ichihara, Tokyo (JP); Akinobu Shuto, Tokyo (JP)

(73) Assignee: Ernst & Young Shinnihon LLC, Tokyo (JP)

(21) Appl. No.: 16/144,568

(22) Filed: Sep. 27, 2018

(30) Foreign Application Priority Data
Sep. 29, 2017 (JP) 2017-191145

(51) Int. Cl. G06Q 40/00; G06F 17/30; G06F 17/16

(52) U.S. Cl. CPC G06Q 40/12; G06F 17/16; G06F 17/30699; G06F 17/30191

(57) ABSTRACT

A financial analysis apparatus includes a first vector generator to generate first vectors having fluctuation of account items within first terms of accounting data, an estimator to estimate fluctuation of the account items within each first term belonging to the second term, a residual calculator to detect a residual between each fluctuation and an actual fluctuation, an anomalous fluctuation identifier to identify an account item in a specific first term, a journal entry pre-extractor to identify journal entries of the accounting data, a journal entry extractor to extract a journal entry including an account item having the value derived from the residual and exceeding the threshold, an anomaly detector to detect whether there is an anomaly in the account item in the extracted journal entry, and an anomalous journal entry extractor to extract a journal entry having the detected anomaly.

### CROSS REFERENCE TO RELATED APPLICATIONS

This application is based upon and claims the benefit of priority from the prior Japanese Patent Application No. 2017-191145, filed on Sep. 29, 2017, the entire contents of which are incorporated herein by reference.

### FIELD

The present invention relates to a financial analysis apparatus, a financial analysis method, and a financial analysis program, using AI (Artificial intelligence) techniques.

### BACKGROUND

AI techniques such as machine learning and deep learning are used in various fields. For example, Japanese Patent No. 6085888 discloses a technique to classify text data into various types of topics and learn a relational structure between the classified topics and other attribute information to quantitatively obtain change in attribute information at the time of topic change, change in topic at the time of attribute information change, etc. Using this technique, matters requiring business improvements, user needs, etc. can be extracted.

The technique of the patent document described above can be applied to financial audit, and risk evaluation can be performed for audit purpose by converting text data included in various documents, which have not been fully utilized, into topics, in order to treat the topics as variables in the same manner as financial information.

However, company's accounting data may be enormous in some cases, although depending on company size, and hence it is not easy to find out the signs of fraud in the accounting data. The patent document described above does not disclose any practical solutions to find out the signs of fraud in an enormous amount of accounting data.

### BRIEF DESCRIPTION OF THE DRAWINGS

FIG. 1 is a functional block diagram schematically showing a configuration of a financial analysis apparatus according to an embodiment of the present invention;

FIG. 2 is a chart showing an example of the hardware configuration of the financial analysis apparatus of FIG. 1;

FIG. 3 is a flowchart showing an example of overall operation of the financial analysis apparatus of FIG. 1;

FIG. 4 is a chart showing TB practical examples;

FIG. 5 is a chart showing an example of fluctuation of account items and regression coefficients, related to fluctuation of accounts receivable;

FIG. 6 is a chart showing an example of a list of account items of high relevance to fluctuation of accounts receivable on the credit side and the value of a regression coefficient of each account item;

FIG. 7 is a chart showing an example of a daily estimation;

FIG. 8 is a chart showing a matrix of numerical values which represent residuals that exceed a threshold;

FIG. 9 is a chart showing an example of a monthly fluctuation of accounts receivable;

FIG. 10 is a chart showing an example of a journal entry vector and a journal entry matrix;

FIG. 11 is a chart showing a practical example of the journal entry matrix;

FIG. 12 is a chart schematically showing a result of an anomaly detection process; and

FIG. 13 is a chart showing a practical example of the result of the anomaly detection process.

### DETAILED DESCRIPTION

A financial analysis apparatus according to one embodiment has; a first vector generator which generates a first vector that contains components, which are fluctuation of account items for the first term of accounting data; an estimator to estimate fluctuation of account items for each first term belonging to the second term, based on the first vectors within the second term; a residual calculator to calculate a residual between fluctuation estimated by the estimator and the actual fluctuation; an anomalous fluctuation identifier to identify an account item, for which a value derived from the residual exceeds a predetermined threshold for a specific first term; a journal entry pre-extractor to identify journal entries of the accounting data for the specific first term belonging to the second term to generate second vectors containing components, which are amounts of account items in each journal entry; a journal entry extractor to extract such journal entries from the second vectors as ones include account items for which the values derived from the residuals exceed the threshold for the specific first term; an anomaly detector to detect whether there are anomalies among the journal entries extracted by the journal entry extractor; and an anomalous journal entry extractor to extract a journal entry having the anomaly detected by the anomaly detector.

Hereinbelow, embodiments of the present invention will be explained with reference to the accompanying drawings. In the present specification and the accompanying drawings, for easy understanding and simplicity of drawings, the explanation and the drawings are partially omitted, modified or simplified. However, the technical contents to the extent that a similar function can be expected will be interpreted to be included in the embodiments.

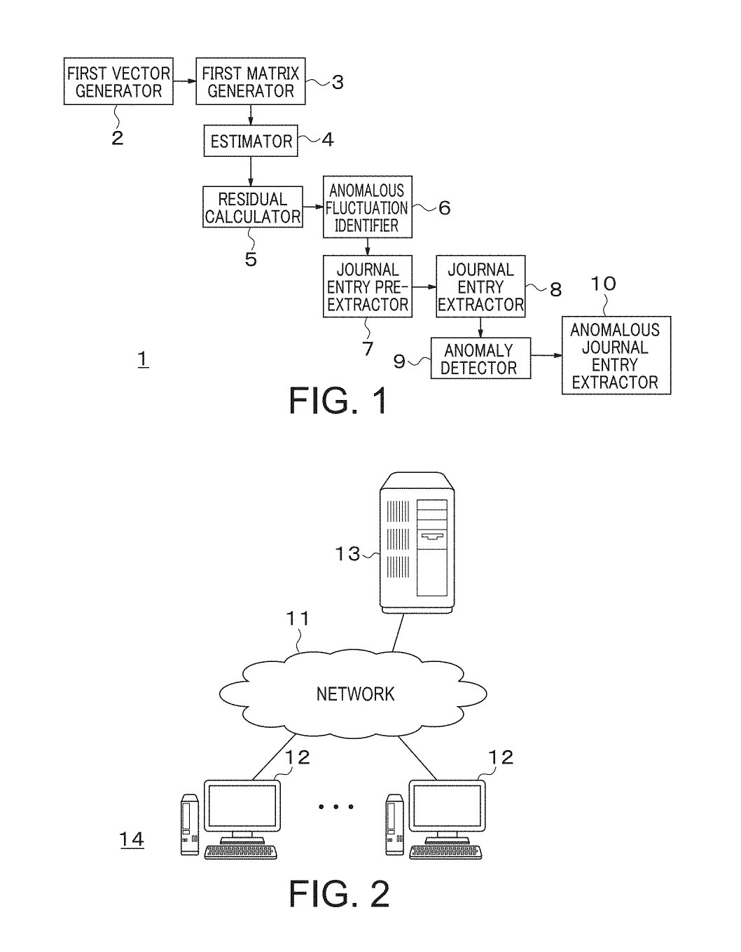

FIG. 1 is a functional block diagram showing a schematic structure of a financial analysis apparatus 1 according to an embodiment of the present invention. The financial analysis apparatus 1 of FIG. 1 is, as described later, configured with at least either one of hardware and software. The financial analysis apparatus 1 of FIG. 1 is equipped with a first vector generator 2, a first matrix generator 3, an estimator 4, a residual calculator 5, an anomalous fluctuation identifier 6, a journal entry pre-extractor 7, a journal entry extractor 8, an anomaly detector 9, and an anomalous journal entry extractor 10.

The first vector generator 2 generates a first vector, which contains components that are fluctuation of account items for the first term of accounting data. The first term is, for example, one day or one month. In a more practical example, the first vector generator 2 calculates daily (monthly) fluctuation in a trial balance (TB) for each account item on the debit side and the credit side separately and generates a first vector including the fluctuation as a component. Hereinafter, the first vector is also referred as a TB fluctuation vector. Therefore, the TB fluctuation vector, for example, includes fluctuation (change in dollar amount) of account items, such as, cash and deposits, merchandise, accounts payable, common stock, sales, and cost of goods sold, as components.

The first matrix generator 3 generates a first matrix of first vectors aligned in a row direction for a second term including first terms. Respective rows in the first matrix are, for example, first vectors with different dates. Hereinafter, the first matrix is also referred to as a daily (monthly) TB fluctuation matrix on respective debit and credit sides. The second term has a duration of a term that is an integer multiple of the first term. The second term is, for example, three months, a half year or one year.

Based on the first matrix, the estimator 4 estimates each fluctuation of account items for each first term belonging to the second term. Accordingly, for example, a fluctuation of each account item is estimated daily (monthly), separately on the debit and credit sides. Hereinafter, an estimated fluctuation is also referred as an estimation, as required. As described later, the estimator 4 estimates a fluctuation of each account item based on a fluctuation model. As a practical example, the estimator 4 estimates each fluctuation of the account items by minimizing the total sum of a value obtained by taking the square of an error in each fluctuation of the account items and absolute values of regression coefficients associated with the account items based on the first matrix (TB fluctuation matrix).

The residual calculator 5 calculates a residual between a fluctuation estimated by the estimator 4 and an actual fluctuation (actual value). For example, the residual calculator 5 calculates a residual of each account item on the debit and credit sides separately on a daily (monthly) basis.

The anomalous fluctuation identifier 6 identifies account items for which a value derived from the residual exceeds a predetermined threshold for a specific first term. The value derived from the residual can be the residual itself detected by the residual calculator 5 or a value obtained by normalizing the residual. The threshold can be any value, which can be determined in accordance with the value derived from the residual. The fluctuation of the specific account item for the specific first term, identified by the anomalous fluctuation identifier 6, is an anomaly suspect. Here, the anomaly means a specific type of fluctuation of an account item, which is beyond imagination according to a regular transaction tendency. The anomaly can indicate accounting fraud, while regular transactions can cause anomaly as well.

The journal entry pre-extractor 7 identifies journal entries of accounting data for the specific first term in the second term identified by the anomalous fluctuation identifier 6, generates a second vector containing components, which are dollar amounts of account items for each journal entries, and generates a second matrix that consists of second vectors aligned in a row direction. Hereinafter, the second vector and the second matrix are also referred to as a journal entry vector and a journal entry matrix, respectively, as required. Each row in the journal entry matrix is the journal entry vector. For example, the journal entry pre-extractor 7 generates journal entry vectors for all journal entries entered on a specific day identified by the anomalous fluctuation identifier 6 and generates a journal entry matrix with journal entry vectors aligned in the row direction.

The journal entry extractor 8 extracts a journal entry that includes an account item for which the value derived from the residual exceeds the threshold, from the second matrix (journal entry matrix). Journal entries in the journal entry matrix include ones for which none of account items are such that the value derived from the residual exceed the threshold. Therefore, the journal entry extractor 8 extracts only journal entries that include account items for which the values derived from the residuals exceed the threshold, from the journal entry matrix. More practically, the journal entry extractor 8 extracts journal entries that include account items for which absolute values of the values derived from the residuals exceed the threshold, irrespective of whether the values derived from the residuals are positive or negative. Taking into consideration whether the value derived from the residual is positive or negative, two kinds of distinctive positive and negative thresholds are required so as to extract a journal entries involving account items for which the residuals show upward or downward swing, resulting in complicated processing. The journal entry extractor 8 extracts all journal entries that include account items for which the absolute values of the values derived from the residual exceed the threshold, irrespective of whether the residuals show upward or downward swing. Therefore, the burden of processing on the journal entry extractor 8 can be mitigated.

The anomaly detector 9 detects anomalies among the journal entries extracted by the journal entry extractor 8. As described later, the anomaly detector 9 uses the k-nearest neighbor algorithm, LOF (Local Outlier Factor) algorithm, etc. to detect anomalies. The anomaly detector 9, for example, outputs a degree of anomaly for each journal entry that is a quantified value showing that the larger the numerical value of the degree of anomaly, the greater the suspicion of anomaly. The anomalous journal entry extractor 10 extracts journal entries for which anomalies are detected by the anomaly detector 9. When the anomaly detector 9 outputs the degree of anomaly, the anomalous journal entry extractor 10 compares the degree of anomaly with a predetermined threshold to extract journal entries that include an account item for which the degree of anomaly is larger than the threshold.

FIG. 2 is a chart showing an example of the hardware configuration of the financial analysis apparatus 1 of FIG. 1. FIG. 2 schematically shows a configuration of a network system 14 provided with personal computers (hereinafter, PC) 12 connected to a network 11 and a file server 13 also connected to the network 11. Accounting data is accumulated in the file server 13 at fixed or non-fixed intervals. At least one of the PCs 12 is, for example, capable of executing a predetermined computer program to perform the operation of the financial analysis apparatus 1 of FIG. 1. Or at least one of the PCs 12 may, for example, be provided as an extension board or the like including hardware that performs the operation of the financial analysis apparatus 1 of FIG. 1. The hardware configuration of the financial analysis apparatus 1 of FIG. 1 is not limited to that shown in FIG. 2, and includes a single standalone PC 12 or workstation to perform the operation of the financial analysis apparatus 1 of FIG. 1.

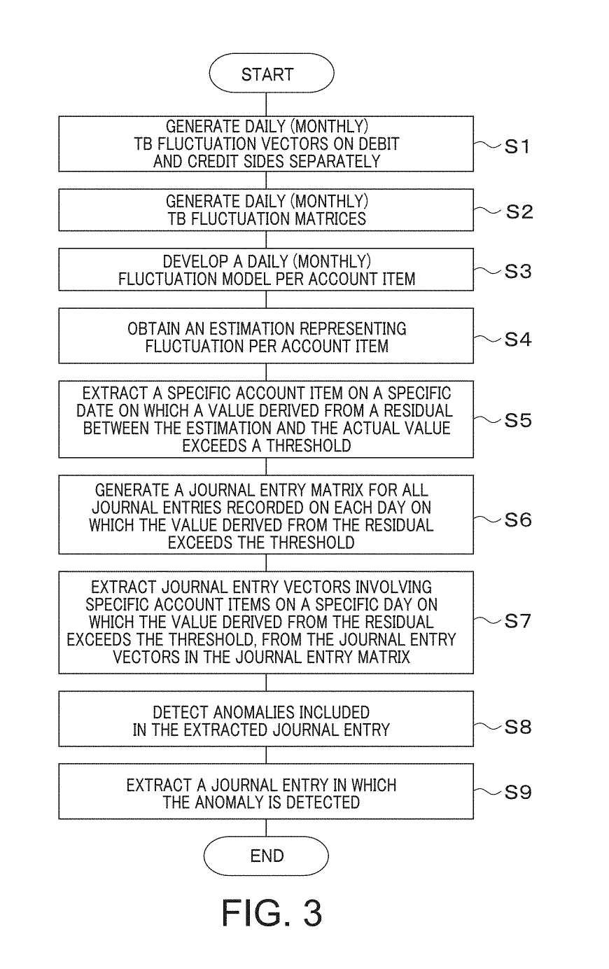

FIG. 3 is a flowchart showing an example of overall operation of the financial analysis apparatus 1 of FIG. 1. First of all, the first vector generator 2 calculates daily (monthly) fluctuation in a trial balance (TB) for each account item on the debit and credit sides separately and generates daily (monthly) TB fluctuation vectors on the debit and credit sides separately (step S1).

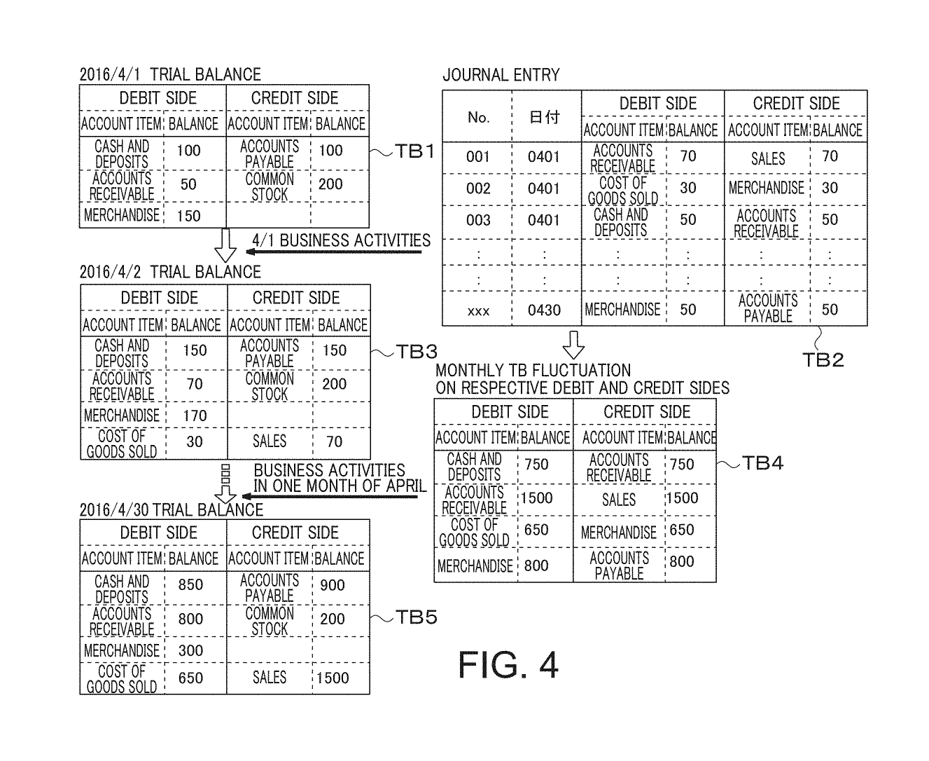

FIG. 4 is a chart showing TB practical examples. In FIG. 4, a TB1 is a trial balance before reflecting Apr. 1, 2016 business activities and a TB2 is a list of journal entries of April 2016. The journal entry list contains all journal entries entered in the month as an example. Fluctuation on the respective debit and credit sides of account items on a specific day (for example, Apr. 1, 2016) in the TB2 are referred to as a TB fluctuation vector that represents daily business activities. For example, the TB fluctuation vector on Apr. 1, 2016 is (70, 30, 50, . . . , 70, 30, 50, . . . ). A TB3 in FIG. 4 is a Apr. 2, 2016 trial balance obtained by reflecting the Apr. 1, 2016 business activities on the TB1. As described, by reflecting the business activities on a given day on the trial balance of the previous day, the trial balance on the next day is determined. This process is repeated day by day to update the trial balance. A TB4 is a list of the total amounts of fluctuation for respective account items in one month of April in 2016 on the respective debit and credit sides. A Apr. 30, 2016 trial balance shown in a TB5 is obtained by adding the TB4 to the TB1.

When step S1 in FIG. 3 is complete, subsequently, the first matrix generator 3 combines daily (monthly) TB fluctuation vectors on the respective debit and credit sides to generate daily (monthly) TB fluctuation matrices on the debit and credit sides separately (step S2). A TB fluctuation matrix is an array of TB fluctuation vectors of different dates aligned in respective rows. Without generating the TB fluctuation matrices, TB fluctuation vectors for multiple dates may be passed to step S3 which will be described below.

Subsequently, the estimator 4 develops a daily (monthly) fluctuation model for each account item on the debit and credit sides separately (step S3). The fluctuation model estimates fluctuation of an account item based on other specific account items automatically selected which are likely to be related to the account item to be estimated. Sparse modeling can be used as a method to build such a model. In the sparse modeling, only relevant explanatory variables are selected as variables to be used for each account item. As a representative of sparse modeling, Lasso (Least Absolute Shrinkage and Selection Operator) is often used.

In usual regressive analysis, a regression coefficient vector β is obtained so as to minimize a total sum Σεi² of values obtained by taking the square of each component εi of an error vector ε in a regression formula of the following formula (1). Here, Y represents a target variable vector and X represents an explanatory variable matrix.

Y=Xβ+ε (1)

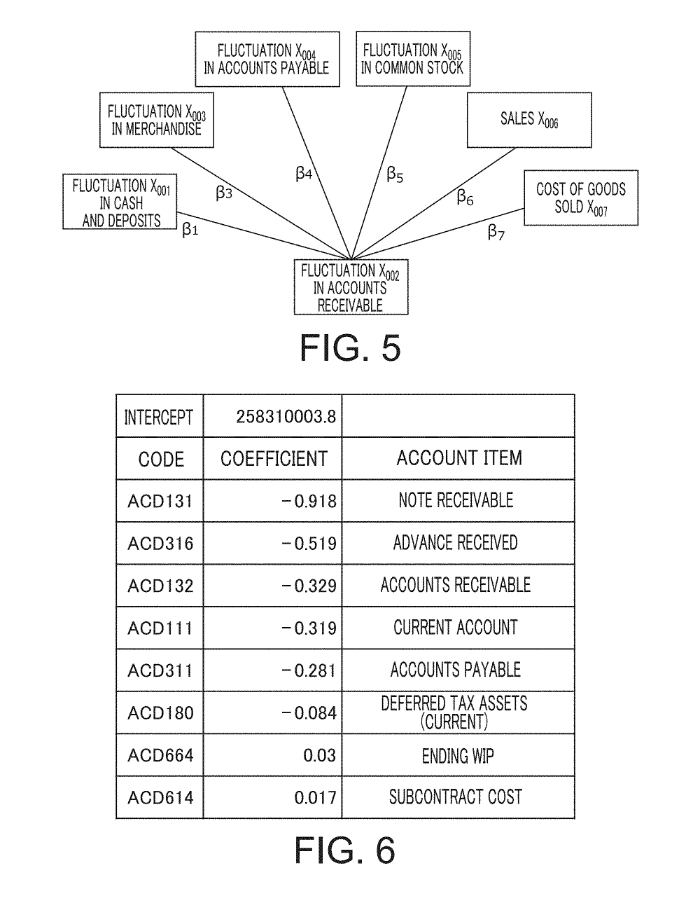

FIG. 5 shows an example in which a fluctuation Y002 in accounts receivable is related to a fluctuation X001 in cash and deposits with a regression coefficient β1, a fluctuation X003 in merchandise with a regression coefficient β3, a fluctuation X004 in accounts payable with a regression coefficient β4, a fluctuation X005 in common stock with a regression coefficient β5, a sales X006 with a regression coefficient β6, and a cost of goods sold X007 with a regression coefficient β7. The fluctuation Y002 in accounts receivable in FIG. 5 can be expressed with the following regression formula (2), if not with vector expression. The left side of the formula (2) may be a fluctuation in an account item on either the debit or credit side or may be net amounts of both sides. On the right side of the formula (2), both terms for all account items on the debit and credit sides, except for the terms used as explained variables, may be provided or terms of account items on either the debit or credit side may be provided.

Y002=β1×X001+β3×X003+β4×X004+β5×X005+β6×X006+β7×X007+ε (2)

When the regression formula is expressed with the formula (2), the regression coefficients β1 to β7 are obtained so that a value, which is obtained by taking the sum of squared errors (difference between a value obtained by the regression formula and an actual value) in the above formula, becomes minimum by ordinary least squares (OLS).

In contrast to OLS, Lasso obtains regression coefficients β that minimizes a value S_{λ}(β) in the following formula (3). Here, λ is a complexity parameter.

S_{λ}(β)=λΣⱼ|βⱼ|+Σᵢεᵢ² (3)

Lasso does not minimize a sum of squared errors as OLS does, but adds a regularization term so that a total of the sum of squared errors and the sum of absolute values of regression coefficients β become minimum. In this way, regression coefficients β of some account items which have low relevance to the explained variable tend to be estimated to be zeros, so that account items of high relevance can only be mechanically extracted from many account items.

As described above, in the fluctuation model estimation of step S3 in FIG. 3, a regression coefficient βj and an explanatory variable Xi are set for each debit-side fluctuation and each credit-side fluctuation per account item respectively to identify account items with non-zero regression coefficients βj required for minimizing S_{λ}(β) of the formula (3). The fluctuation of identified account items Xi and their regression coefficients βj are then substituted in the formula (2) to obtain an estimation (step S4). The estimation represents a fluctuation on each of the debit and credit sides per account item.

FIG. 6 is a chart showing an example of a list of account items of high relevance to a fluctuation in accounts receivable on the credit side and the value of a regression coefficient βj for each account item. It is shown in the example of FIG. 6 that the fluctuation in accounts receivable on the credit side is highly relevant to a note receivable, an advance received, accounts receivable, a current account, accounts payable, deferred tax assets, an ending WIP, and a subcontract cost.

When a fluctuation is estimated in step S4 of FIG. 3, subsequently, the anomalous fluctuation identifier 6 extracts a specific account item on a specific date on which a value derived from a residual between the estimation and the actual value exceeds a threshold (step S5). The residual itself may be compared with the threshold or the residual may be normalized with a standard deviation which is then compared with the threshold. Hereinbelow, an example will be explained in which the residual is compared with the threshold.

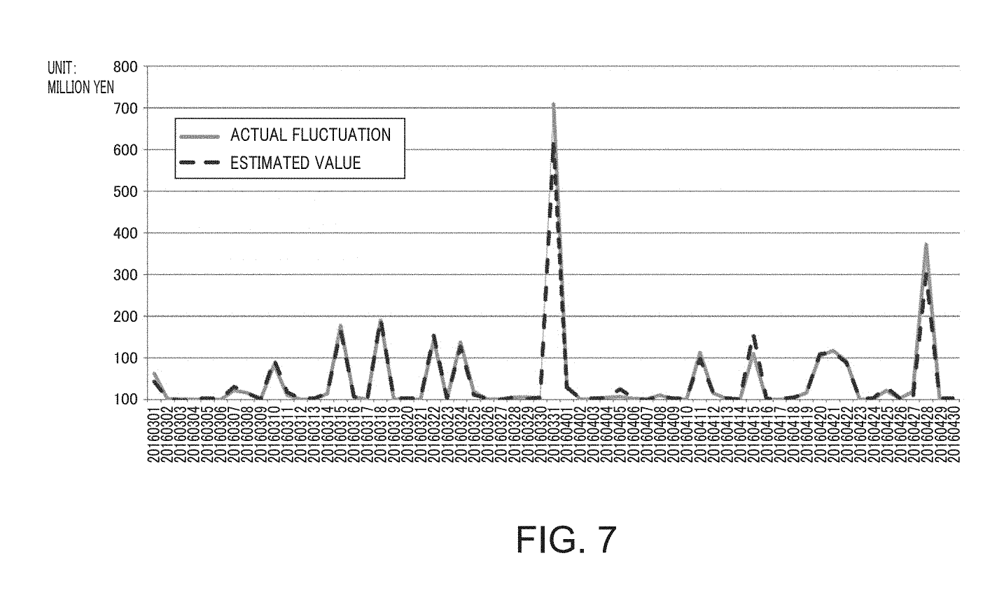

FIG. 7 is a chart showing an example of a daily estimation (with a broken line) and actual fluctuation (with a solid line) of accounts receivable on the credit side. In FIG. 7, the horizontal axis represents dates and the vertical axis represents fluctuation (in million yen), respectively. As understood from FIG. 7, the estimated fluctuation of accounts receivable on the credit side matches with the actual fluctuation on most days, with a difference on some days. The differences represent residuals. The daily estimation such as shown in FIG. 7 is generated per account item for each of the debit and credit side.

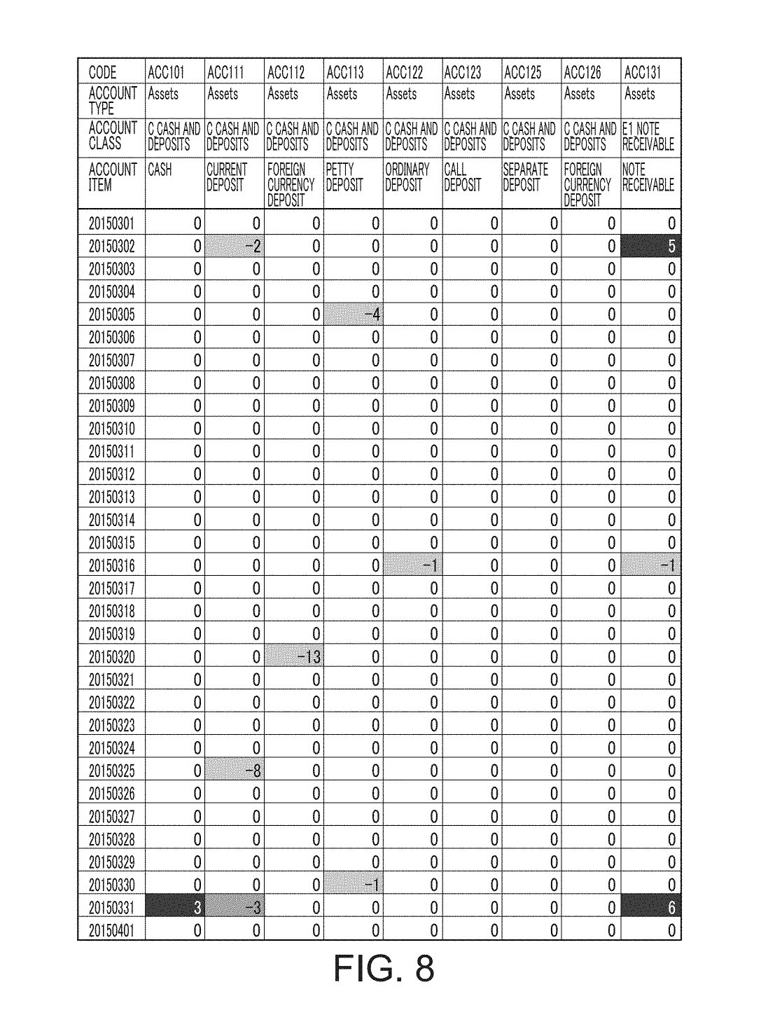

FIG. 8 is a chart showing a matrix of numerical values which represent residuals that exceed the threshold. Respective rows of the matrix represent values derived from residuals of account items on different days. The values in the matrix of FIG. 8 indicate how large the difference between estimation and actual values in a unit of standard deviation a. When the value is large, it is inferred that there is a non-recurring activity to an account item on a specific day. Nevertheless, non-recurring activity is not always fraud, but may be an authentic activity which rarely occurs.

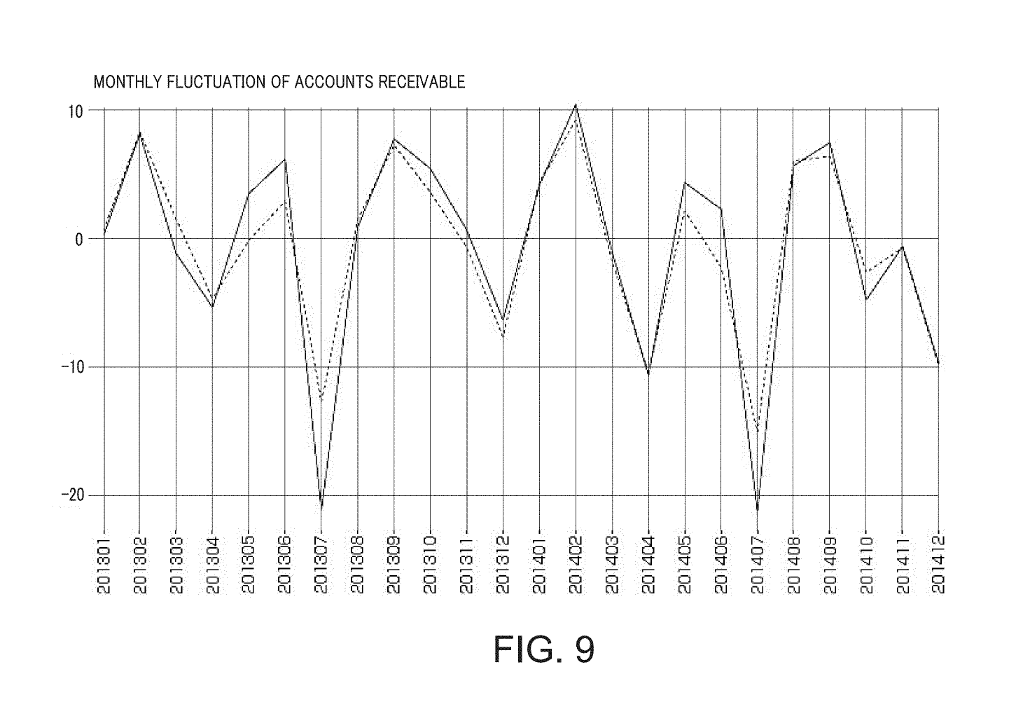

FIG. 9 is a chart showing an example of monthly fluctuation of accounts receivable. In FIG. 9, the broken line indicates estimation of monthly fluctuation of accounts receivable using Lasso whereas the solid line indicates actual monthly fluctuation of accounts receivable. As shown in FIG. 9, in analysis by Lasso, the relationship between account items is largely grasped to develop a fluctuation model, so that, when an actual monthly fluctuation is largely deviated from an estimation, it is suggested that an unusual account item is associated with the accounts receivable. Irregular accounting activity can be identified by looking at change in the relationship among account items, rather than by looking at large fluctuation in each account item.

When step S5 in FIG. 3 is complete, the journal entry pre-extractor 7 generates a journal entry matrix for all journal entries recorded on each day on which the value derived from the residual between the estimation and the actual fluctuation exceeds the threshold (step S6). Each row in the generated journal entry matrix is a journal entry vector. Without generating the journal entry matrix, journal entry vectors of all journal entries recorded on the identified days may be passed to step S7 which will be described later.

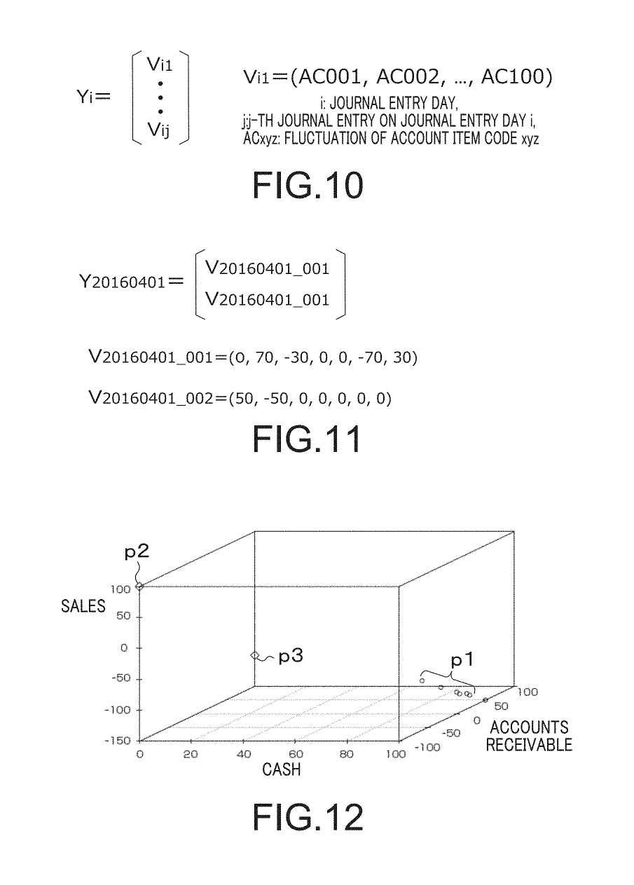

FIG. 10 is a chart showing an example of a journal entry vector and a journal entry matrix. A journal entry matrix Yi is an array of journal entry vectors Vi1 to Vij aligned in a row direction for all journal entries on a journal entry day i on which the value derived from the residual between the estimation and the actual fluctuation exceeds the threshold. The sign j represents a j-th journal entry on the journal entry day i. The journal entry vector Vij is expressed as Vij=(AC001, AC002, . . . , AC100). Each component ACxyz of the journal entry vector Vij is a fluctuation of an account item code xyz.

FIG. 11 is a chart showing a practical example of the journal entry matrix. A journal entry matrix Y20160401 on Apr. 1, 2016 is composed of two journal entry vectors V20160401_001 and V20160401_002 which are an example of journal entry vectors having components that are fluctuation of cash and deposits, accounts receivable, merchandise, accounts payable, common stock, sales, and cost of goods sold. A journal entry vector can be composed of any kinds of account items which are not limited to those shown in FIG. 11.

When step S6 in FIG. 3 is complete, subsequently, the journal entry extractor 8 extracts journal entry vectors involving specific account items on a specific day on which the value derived from the residual between the estimation and the actual value exceeds the threshold, from the journal entry vectors in the journal entry matrix (step S7). Here, only journal entry vectors involving specific account items for which the value derived from the residual between the estimation and the actual value exceeds the threshold, are extracted to generate a third matrix (journal entry extraction matrix) that has all account items, which are included in each extracted journal entry vector and aligned in a column direction. Each row in the journal entry extraction matrix is a third vector (journal entry extraction vector) that corresponds to each journal entry. Some columns of the journal entry extraction matrix are omitted when corresponding account items are not used in any journal entry in the journal entry extraction matrix.

When step S7 in FIG. 3 is complete, subsequently, the anomaly detector 9 detects anomalies included in the extracted journal entry (each journal entry extraction vector in the journal entry extraction matrix) (step S8). When an anomaly is detected, the anomalous journal entry extractor 10 extracts a journal entry in which the anomaly is detected (step S9).

FIG. 12 is a chart schematically showing a result of an anomaly detection process performed by the anomaly detector 9. A group of plotted circles p1 represents ordinary sales journal entries. Amounts of cash and accounts receivable varies from 50 to 100, and the amounts of sales are total sum of the cash and the accounts receivable with a negative sign. By contrast, a plotted diamond p2 represents a journal entry of unusual transaction with no cash, accounts receivable of −100, and sales of 100, which is a cancellation of sales with accounts receivable. Another plotted diamond p3 represents a journal entry of unusual transaction with no cash, accounts receivable of 100, and sales of −100, which is a sales transaction with accounts receivable for the entire amount, in contrast to usual transaction being mixture of sales of cash and accounts receivable. The journal entries of the plotted diamonds p2 and p3 are located away from each journal entry of the group of plotted circles p1 in the vector space and hence they can be detected as anomalous journal entries according to the distance between the plots.

For anomaly detection, 1) methods based on statistical distribution, 2) methods based on distance or 3) methods based on density can be used.

As a method based on statistical distribution, for example, Hotelling theory can be used. The Hotelling theory is a way to calculate the degree of anomaly by calculating mean and standard deviation based on given data, dividing deviation (Mahalanobis distance) between an observation value and the mean by the standard deviation (normalization), and taking the square of the normalized value. However, since this method assumes a normal distribution as data distribution, it may not fit well journal entries having irregular distribution, with many variations.

Under such a circumstance, methods based on distance are used. As a representative one, the k-nearest neighbor method is well known. The k-nearest neighbor method measures the degree of anomaly according to the distance from an observation value to the k-th closest data, k being a number determined beforehand. In more practically, extracted journal entries are compared one another to detect a journal entry which is the k-th closest to a given journal entry in the Euclidean distance and then the distance to the detected journal entry is determined as the observation value. The Euclidean distance between two journal entries is obtained by comparing two journal entry extraction vectors corresponding to the two journal entries. Based on the assumption that outliers should diverge from other journal entry extraction vectors, those that are away from the k-th closest journal entry extraction vector are regarded as anomalies. However, when considering the application to journal entry extraction vectors, since the density of each journal entry extraction vector is not uniform, it is difficult to determine k which is appropriate over the whole area.

Methods used when the density of each journal entry extraction vector is not uniform are methods based on density, and the local outlier factor (LOF) is well known. The LOF is such a method that, based on the ratio of the distance from an observation value to the nearest data (nearest neighbor point) and the distance from the nearest neighbor point to the nearest data, the point where the density becomes lower than the neighborhood is defined as an anomaly.

It is possible to be extended to the form of the ratio of the distance using multiple neighbor points instead of the comparison between the observation value and the nearest neighbor point alone. Therefore, it is an effective method to perform anomaly detection using the LOF with vectors representing journal entries.

However, since the number of account items used in journal entries in real practice is hundreds to thousands, the dimension of journal entry vectors and journal entry extraction vectors becomes very large. In this case, the distance between data could become equal to each other, and hence anomaly detection may be difficult. For this reason, it is necessary to devise an anomaly detection method in high dimensional spaces, to perform anomaly detection with dimensionality reduction in some way, and so on.

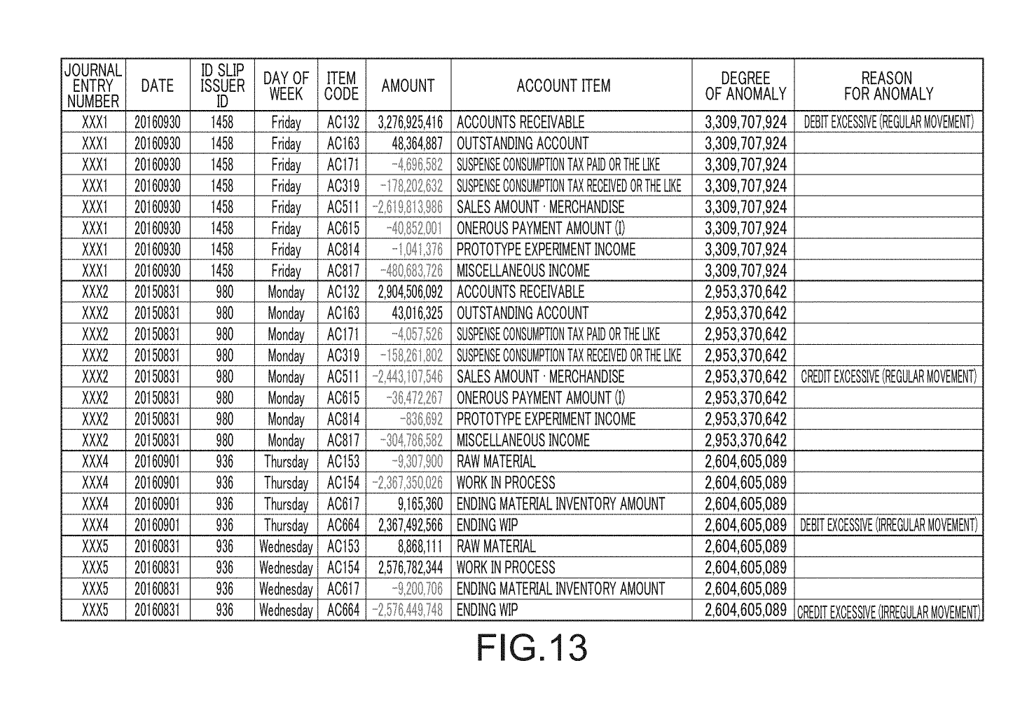

FIG. 13 is a chart showing a practical example of the result of the anomaly detection performed by the anomaly detector 9. FIG. 13 shows four journal entries XXX1, XXX2, XXX4, and XXX5, which are identified as anomalies. The journal entry XXX1 is identified as anomaly to have the residual (value derived from the residual) of the accounts receivable on the debit side exceeding the threshold and also to have the degree of anomaly exceeding the other threshold at the anomaly detector 9. The journal entries XXX2, XXX4, and XXX5 are similar to the journal entry XXX1. The journal entry XXX2 is identified to have excessive fluctuation of the sales and merchandise on the credit side. The journal entry XXX4 is identified to have excessive fluctuation of the ending WIP on the debit side. The journal entry XXX5 is identified to have excessive fluctuation of the ending WIP on the credit side.

As described above, in the present embodiment, it is performed to develop a fluctuation model of each account item, estimate a fluctuation of each account item based on the fluctuation model, and then extract a specific account item on a specific day on which a value derived from a residual between the estimated fluctuation (estimation) and an actual value is larger than a threshold. Subsequently, it is performed to generate a journal entry vector having account items of all journal entries on the specific day aligned in a column direction, extract a journal entry vector including the specific account items from generated journal entry vectors, and then perform anomaly detection of whether there are anomalies among the extracted journal entry vectors.

Accordingly, an irregular journal entry can be identified as anomaly and extracted automatically and effectively from journal entries involving many account items. Therefore, an irregular pattern of accounting activity, which cannot be identified based on assumptions made by accountants or human, can be detected. This strength is useful for prevention of accounting fraud.

At least part of the financial analysis apparatus 1 explained in the embodiment may be configured with hardware or software. When it is configured with software, a program that performs at least part of the financial analysis apparatus 1 may be stored in a storage medium such as a flexible disk and CD-ROM, and then installed in a computer to run thereon. The storage medium may not be limited to a detachable one such as a magnetic disk and an optical disk but may be a standalone type such as a hard disk and a memory.

Moreover, a program that achieves the function of at least part of the financial analysis apparatus 1 may be distributed via a communication network a (including wireless communication) such as the Internet. The program may also be distributed via an online network such as the Internet or a wireless network, or stored in a storage medium and distributed under the condition that the program is encrypted, modulated or compressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A financial analysis apparatus comprising:
a first vector generator to generate first vectors having fluctuation of account items within first terms of accounting data, as components;
an estimator to estimate fluctuation of the account items for each first term belonging to the second term, based on the first vectors within a second term;
a residual calculator to calculate a residual between each fluctuation estimated by the estimator and an actual fluctuation;
an anomalous fluctuation identifier to identify an account item, for which the value derived from the residual exceeds a predetermined threshold for a specific first term;
a journal entry pre-extractor to identify journal entries of the accounting data for the specific first term belonging to the second term to generate second vectors containing components, which are amounts of account items in each journal entry;
a journal entry extractor to extract such journal entries from the second vectors as ones include account items for which the values derived from the residuals exceed the threshold for the specific first term;
an anomaly detector to detect whether there are anomalies among the journal entries extracted by the journal entry extractor; and
an anomalous journal entry extractor to extract a journal entry having the anomaly detected by the anomaly detector.

2. The financial analysis apparatus of claim 1, wherein the first vector generator generates the first vectors having the fluctuation of the account items, the fluctuation being aligned in a column direction, on the debit and credit sides separately, and
the estimator estimates the fluctuation of the account items, on the debit and credit sides separately.

3. The financial analysis apparatus of claim 1, wherein the estimator estimates the fluctuation of the account items by minimizing a total sum of a value derived by taking square of an error in the fluctuation of the account items, and absolute values of regression coefficients associated with the account items, respectively.

4. The financial analysis apparatus of claim 1 further comprising a normalizer to normalize the residual calculated by the residual calculator,
wherein the anomalous fluctuation identifier compares a value obtained by normalizing the residual by the normalizer with the threshold.

5. The financial analysis apparatus of claim 1 further comprising a first matrix generator to generate a first matrix having the first vectors in the second term including the first terms, the first vectors being aligned in a row direction;
wherein the estimator estimates the fluctuation of the account items for each first term belonging to the second term, based on the first matrix,
the journal entry pre-extractor generates a second matrix having the second vectors generated per journal entry and aligned in the row direction, and
the journal entry extractor extracts journal entries involving account items for which the values derived from the residuals exceed the threshold from the second matrix.

6. The financial analysis apparatus of claim 1, wherein the journal entry extractor extracts journal entries involving account items for which the values derived from the residuals exceed the threshold from the second matrix, generates third vectors having fluctuation of account items in the extracted journal entries, the fluctuation being aligned in a column direction, and generates a third matrix of the generated third vectors aligned in a row direction, and
the anomaly detector detects whether there are anomalies among the third vectors extracted by the journal entry extractor.

7. The financial analysis apparatus of claim 6, wherein the first vector generator generates the first vectors having a value of zero for a non-fluctuating account item,
the journal entry pre-extractor generates the second vectors having a fluctuation of zero for an account item not included in each journal entry, and
the journal entry extractor generates the third vectors including a fluctuation of an account item only included in each journal entry.

8. A computer executable financial analysis method comprising:
generating first vectors having fluctuation of account items within first terms of accounting data, as components,;
estimating fluctuation of the account items for each first term belonging to the second term, based on the first vectors within a second term including the first terms;
calculating a residual between each fluctuation estimated by the estimator and an actual fluctuation;
identifying an account item for which a value derived from the residual exceeds a predetermined threshold for a specific first term;
identifying journal entries of the accounting data for the specific first term belonging to the second term to generate second vectors containing components, which are amounts of account items in each journal entry;
extracting such journal entries from the second vectors as ones include account items for which the values derived from the residuals exceed the threshold;
detecting whether there are anomalies among the extracted journal entries; and
extracting the journal entry having the detected anomaly.

9. A non-transitory computer readable storage medium having stored therein computer executable financial analysis method comprising:
generating first vectors having fluctuation of account items within first terms of accounting data, as components;
estimating fluctuation of the account items for each first term belonging to the second term, based on the first vectors within a second term including the first terms;
calculating a residual between each fluctuation estimated by the estimator and an actual fluctuation;
identifying an account item for which a value derived from the residual exceeds a predetermined threshold for a specific first term;
identifying journal entries of the accounting data for the specific first term belonging to the second term to generate second vectors containing components, which are amounts of account items in each journal entry;
extracting such journal entries from the second vectors as ones include account items for which the values derived from the residuals exceed the threshold;
detecting whether there are anomalies among the extracted journal entries; and
extracting the journal entry having the detected anomaly.
